(19) United States
(12) Patent Application Publication
(10) Pub. No.: US 2025/0069433 A1
(43) Pub. Date: Feb. 27, 2025

(54) FILTERING SUBJECTS SUBJECT TO FACIAL IMAGE PROCESSING IN A FACE-TRACKING ENVIRONMENT

(71) Applicant: THALES DIS USA, INC., Austin, TX (US)

(72) Inventors: Scott SIX, Gloucester, VA (US); Christopher HARTMAN, Williamsburg, VA (US)

(73) Assignee: THALES DIS USA, INC., Austin, TX (US)

(21) Appl. No.: 18/454,088

(22) Filed: Aug. 23, 2023

(51) Int. Cl. G06V 40/16; G06V 10/44

(52) U.S. Cl. CPC G06V 40/172; G06V 10/44; G06V 40/165; G06V 40/171

(57) ABSTRACT

Filtering subjects subject to facial image processing in a face-tracking environment by capturing at least one image using an image capture device, defining an inclusion polygon having at least three vertices such that at least one angle formed at least one of said vertices is not a right angle, identifying a plurality of faces in said at least one image, defining a geometric shape around each said identified plurality of faces, respectively, excluding from further processing any of said identified faces with a defined geometric shape that that fails an inclusion criteria. Performing further processing on not-excluded identified faces to thereby determine an identification-linked property linked to such identified faces.

### BACKGROUND

The present disclosure relates, generally, to facial image acquisition systems, and, more particularly, to mechanisms for selecting facial images captured by image capture devices for further processing or excluding facial images captured by image capture device from further processing.

Facial image acquisition systems, such as the Cogent Face Recognition Platform (FRP) from the Thales Group, headquartered in Paris, France, provide powerful technologies for recognizing the presence of faces in captured images. The captured faces may be further processed for a large variety of purposes. For example, through biometric algorithms facial recognition technology may be used to determine the identity of an individual whose facial image has been captured by an image capture device. The determination of identity can then be used to access some property associated with the individual, e.g., the authorization for passage through a gate of some sort.

One scenario, which may be considered as an illustrative example, is passage through a security control at an airport. An image capture device may capture images of travelers going through the control checkpoint, analyze those images to find faces, process the captured facial images, obtain the associated ID of an individual that match the facial image, and either allow passage or deny passage through the checkpoint based on some properties associated with the individual, e.g., having been pre-authorized for passage through the checkpoint, not on a watchlist, and being the holder of a valid boarding pass for travel during a specified period of time.

However, while such technology is extremely useful in, for example, reducing time through checkpoints, etc., providing a high level of security, and reducing the risk of poor accuracy associated with having identification checks performed by tired, bored, and overworked human agents, a fairly large portion of the population simply do not want to be subjected to such facial recognition technology. Furthermore, some individuals, for privacy and security reasons, should not be subjected to certain facial recognition operations.

Therefore, it is desirable to have a technology that limits facial image acquisition to individuals who through some action has placed themselves such that it can be inferred that they have acquiesced to having their facial image processed and used for identification purposes while in parallel excluding from further processing any facial images that may have been captured by an image processing device but where such an inference of acquiescence cannot be made or where the individual has placed themselves such that it can be inferred that they have not made such an acquiescence.

Furthermore, in many situations there is a one-to-one mapping between an individual and some form of credential. Consider, for example, travel documents. Typically, each individual has their own passport, ticket, and boarding card. In systems where biometrics or other facial image processing is used to link individuals to their travel documents, it is desirable to capture precisely one facial image at a time and excluding any other faces that may have been captured by an image capture device. For example, if travelers are bunched up very close to one another, there is a high likelihood of more than one face being present in a captured image. Therefore, it is desirable to provide an improved filter technology to captured faces so as to only apply facial image processing to faces that should be subject to such facial image processing and excluding from processing faces that should not be subject to further facial image processing.

Some facial image acquisition systems, for example, provide simple invisible rectangular regions defined in captured images where faces that fall outside of the rectangular region are not included for facial image acquisition whereas faces that fall inside of the rectangular region are included. It has been demonstrated that such a fixed rectangular acquisition region does not provide accurate exclusion of faces that should not be acquired or is over exclusive. Use of fixed rectangular acquisition regions typically sacrifice height to limit acquisition width, thereby risking excluding from acquisition individuals that fall outside the prescribed height of the acquisition region, e.g., very short adults or children. Further, in situations with a lack of distance between individuals, it is quite likely that images of multiple individual faces are acquired simultaneously.

It is desirable to operate a facial image acquisition system at some distance from subjects. In such an environment, a simple rectangular cropping region is likely to exclude images of faces that should be included for processing, likely to be over inclusive and not exclude images of faces that should be excluded or is likely to capture multiple faces when only one face should be processed.

In prior art facial image acquisition systems, there has been a lack of information to individuals subject to image capture technology as to whether such individuals' facial image is being acquired by the facial image acquisition technology.

From the foregoing it is apparent that there is a need for an improved method to determining in captured images whether a face that is identified in the captured images should be included in the facial image acquisition system for further processing.

### SUMMARY

A technology is presented that provides an improved mechanism for determining in captured images whether a face that is identified in the captured images should be included in the facial image acquisition system for further processing by for filtering subjects subject to facial image processing in a face-tracking environment.

In an aspect the image processing technology described herein includes capturing at least one image using an image capture device and defining an inclusion polygon having at least three vertices such that at least one angle formed at least one of said vertices is not a right angle. The technology identifies a plurality of faces in said at least one image and defines a geometric shape around each said identified plurality of faces, respectively. The technology excludes, from further processing, any of said identified faces with a defined geometric shape that falls outside the inclusion polygon or that intersects with the polygon and that fails an inclusion criteria based on an inside portion of the defined geometric shape that falls inside the polygon and an outside portion that falls outside the inclusion polygon. Such identified faces with a defined geometric shape that falls entirely inside the inclusion polygon or that intersects the inclusion polygon and that passes the inclusion criteria are presented for further processing to thereby determine an identification-linked property linked to such identified faces.

In an aspect, further processing includes biometric analysis of the identified faces, and the method further including linking the identification-linked property to face-recognition biometrics for a plurality of individuals.

In a further aspect, the inclusion polygon is defined in a user interface by, for example, specifying vertex coordinates in captured images or by selecting vertices and dragging selected vertices to desired locations or by setting the vertices defining the inclusion polygon based on said identified features.

The inclusion polygon may be selected from the set including triangles, non-rectangular quadrilaterals, pentagons, and hexagons.

In an aspect, the defined geometric shapes around each identified plurality of faces are face polygons and the inclusion criteria with respect to each face polygon is that at least n vertices of the face polygon falls on or within the inclusion polygon, wherein n is a user-defined parameter.

In an aspect, the defined geometric shapes around each said identified plurality of faces are face polygons and the inclusion criteria with respect to each said face polygon is that at least a defined number of corners of said face polygon falls on or within the inclusion polygon. Alternatively, the defined geometric shapes around each identified plurality of faces are face polygons having a plurality of vertices and the inclusion criteria with respect to each said face polygon is that at least a defined number of the vertices of the face polygon falls on or within the inclusion polygon.

In an aspect, the face polygon may be a rectangle.

In an aspect, the identification-linked property may identify individuals as having right to admission selected from the set including having a boarding pass to a flight or other mode of transportation, being the bearer of a passport, having right to building access.

In an aspect, the above described technology may be implemented on a computer system for delimiting subjects from consideration in biometric matching using face-tracking technology having a processor, at least one image capture device, and a memory for storing a database linking an identification property to face-recognition biometrics, and a computer program executable by the processor to perform the herein described technology.

### BRIEF DESCRIPTION OF THE DRAWINGS

FIG. 1 is a perspective view of an environment in which face capture and face tracking may be used to provide a service based on face capture or face tracking obtained from image capture devices and in which some individuals should be included in face capture and face tracking whereas other individuals should be excluded from face capture and face tracking.

FIG. 2 is a top view of the environment in which face capture and face tracking may be used to provide a service based on face capture or face tracking obtained from image capture devices and in which some individuals should be included in face capture and face tracking whereas other individuals should be excluded from face capture and face tracking of FIG. 1.

FIG. 3 illustrates a first problem encountered with a rectangular capture region as may be encountered in prior art systems.

FIG. 4 illustrates a second problem encountered when using a rectangular capture region.

FIG. 5 is a high-level block diagram of a computer system for analyzing image capture that includes face capture or face tracking.

FIG. 6 is a high-level hardware architecture diagram of the computer and data storage of FIG. 5.

FIG. 7 is a flow-chart illustrating steps to include and exclude facial images obtained through the image capture devices of FIG. 1.

FIG. 8 is a display of a rendering of an image captured by the image capture devices of FIG. 1 including an inclusion polygon.

FIG. 9 illustrates addition of face-circumscribing geometric shapes used to determine whether a facial image should be included in further image processing.

FIG. 10 illustrates a user interface by which an operator may modify a shape of an inclusion polygon, for example, as illustrated in FIG. 8, by changing vertex locations defining the inclusion polygon.

FIG. 11 illustrates modification to vertex locations in the user interface of FIG. 10.

FIG. 12 illustrates a modified inclusion polygon in the rendering of FIG. 8.

### DETAILED DESCRIPTION

In the following detailed description, reference is made to the accompanying drawings that show, by way of illustration, specific aspects of the disclosure. These aspects are described in sufficient detail to enable those skilled in the art to practice the aspects of the disclosure. It is to be understood that the various aspects of the disclosure, although different, are not necessarily mutually exclusive. For example, a particular feature, structure, or characteristic described herein in connection with one aspect may be implemented within other aspects without departing from the spirit and scope of the disclosure. In addition, it is to be understood that the location or arrangement of individual elements within each disclosed aspect may be modified without departing from the spirit and scope of the disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The following description includes references to various methods executed by a processor of an integrated circuit chip. As is common in the field, there may be phrases herein that indicate these methods or method steps are performed by software instructions or software modules. As a person skilled in the art knows, such descriptions should be taken to mean that a processor, in fact, executes the methods, software instructions, and software modules.

The herein described technology provides an improved mechanism for filtering captured facial images in conjunction with processing facial images by a facial image processing system.

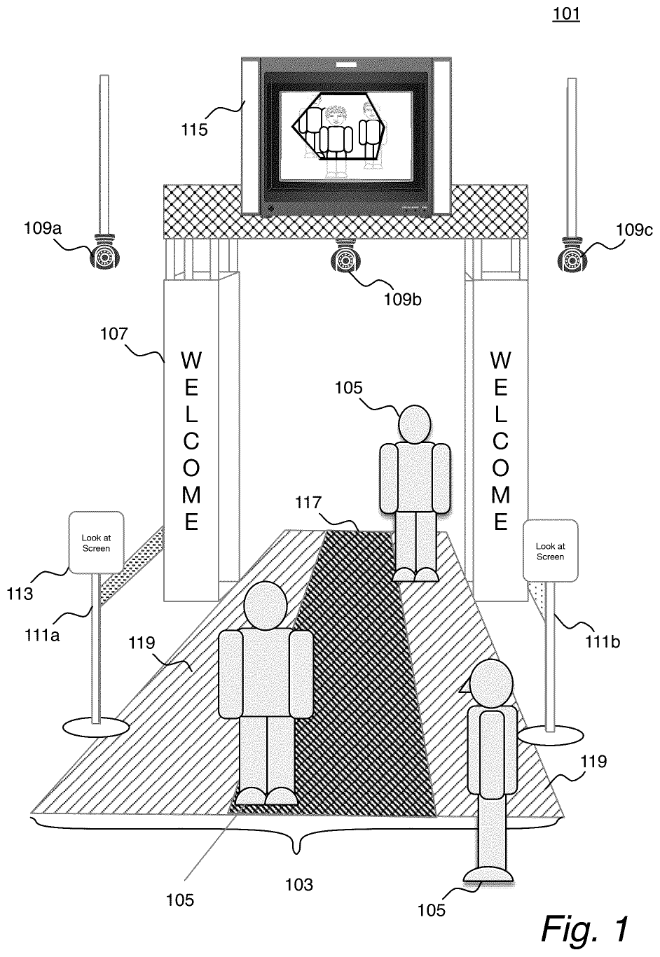

FIG. 1 is a perspective view of an environment 101 in which face capture and face tracking may be used to provide a service based on images captured in face capture or face tracking obtained from one or more image capture devices and in which some individuals should be included in face capture and face tracking whereas other individuals should be excluded from face capture and face tracking. The environment 101 includes a lane 103 down which subjects 105, e.g., airline passengers, walk on their way through a gate 107.

One or more image capture devices 109a-c, e.g., digital cameras, capture images, particular digital images of subjects' faces. Subjects here being individuals passing through some form of filter, e.g., airline passengers and crew entering a flight or passing through a security checkpoint. Many other scenarios apply. For example, subjects can be employees entering a place of business, students entering a school, or attendees to a ticketed event such as a show, sporting event, or conference. These are only examples, a person skilled in the art will realize many more applications for the technology described herein.

In an embodiment, a recognized digital image of a face may be linked to an entry credential, e.g., a person's digital representation of their face may be linked to their boarding pass, passport, employee badge, or movie ticket.

As noted, while image processing of facial images is appropriate for many subjects, other subjects should be excluded from facial image processing. Examples include individuals who for security reasons should not be exposed to an image processing procedure and individuals who, for privacy or personal reasons, simply elect to not participate in an opportunity to have the digital image of their faced used for authenticating themselves in a screening procedure.

The lane 103 may be delineated by some physical barriers 111a-b, e.g., stanchions supporting a ribbon attached to the image-capture gate 107 to allow certain individuals a way to bypass the image capture area. However, for some purposes, all subjects may be required to pass through a common gate structure.

Thus, individuals who opt in to participating in the facial image processing process traverse the environment 101 through a specific area of lane 103 whereas individuals who do not want to participate in facial image processing traverse the environment 101 outside of that image capture area. In other words, in an embodiment, the lane 103 is divided into a region in which image capture occurs, referred to as in lane 117 and areas in which image capture does not occur, referred to as out lanes 119.

Individuals walking through the image capture lane 103 may be provided instructions 113, e.g., to look at the screen, i.e., the monitor 115, or to confirm that they are showing up in the image capture. Conversely, the monitor 115 may provide the individuals walking through the image capture lane with feedback, e.g., a playback of the image being captured so that they can see that they are positioning their face in a manner suitable for facial image processing, that they are walking in an area that excludes them from facial image processing, or instructions to position themselves closer to the screen.

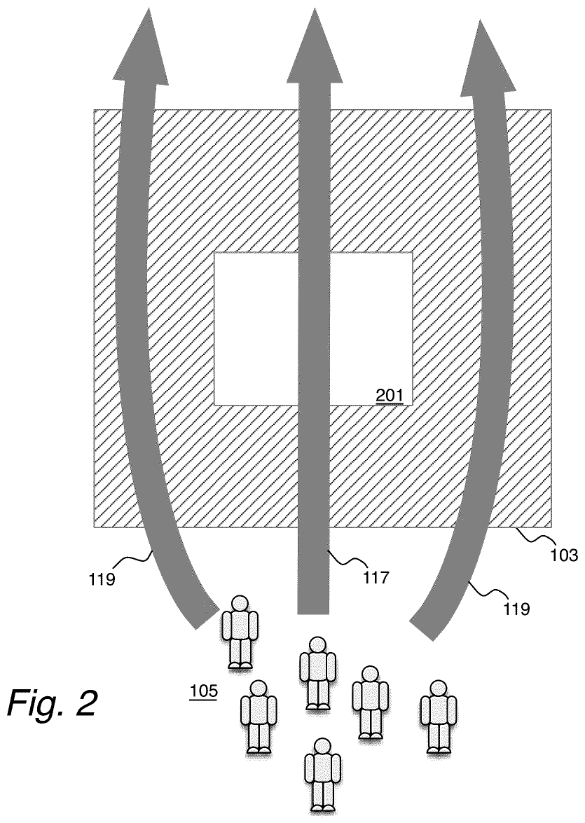

FIG. 2 is a top view of the environment 101 in which face capture and face tracking may be used to provide a service based on face capture or face tracking obtained from image capture devices 109 and in which some individuals 105 should be included in face capture and face tracking whereas other individuals 105 should be excluded from face capture and face tracking of FIG. 1. The image capture lane, thus, includes a consent region 201. Individuals 105 who pass through the consent region 201 implicitly consent to having images capture of their faces and to have such facial images processed by an image processing system.

To avoid the consent region 201, individuals walk down one of the out lanes 119. Conversely, individuals who participate in the facial image processing, for example, to gain entry through the environment 101 based on facial recognition, walk down the in lane 117.

Filtering individuals whose facial images should be processed as they traverse the environment 101 is one aspect of the present technology. Another is to process images such that only one face is processed at a time.

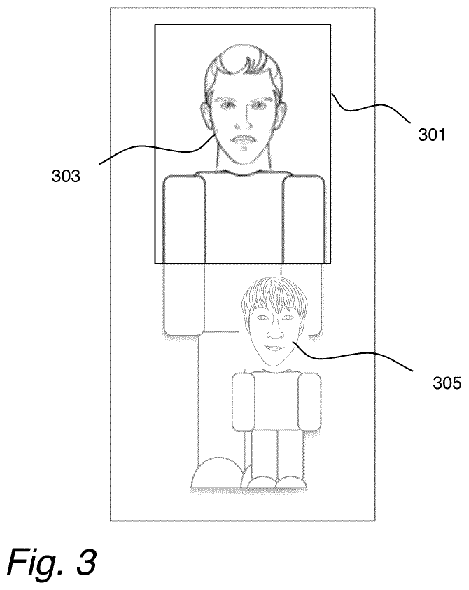

FIG. 3 illustrates a rectangular inclusion region 301 as may be encountered in prior art systems. In this example, the inclusion region 301 is designed to capture images of faces of adults within a usual range of heights of adults. Thus, the image of the face of the man 303 is readily captured by the inclusion region 301. However, the shorter person or child 305 goes undetected by the image processing system.

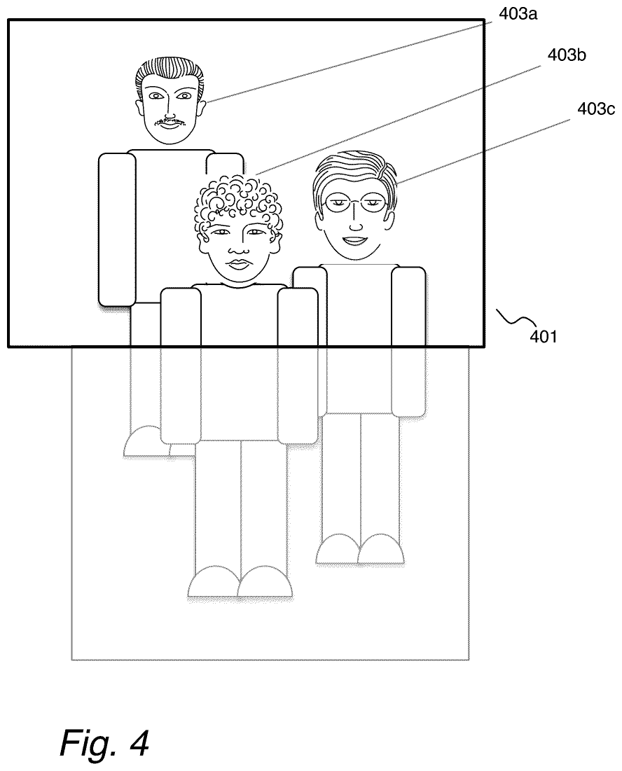

FIG. 4 illustrates another problem encountered when using a rectangular inclusion region 401. In this example, the inclusion region is rather wide and thus includes multiple faces 403, which is undesirable.

As discussed hereinbelow, the present technology provides an improved mechanism for filtering faces detected in images captured in an environment 101 to select facial images for processing and excluding facial images that should not be processed.

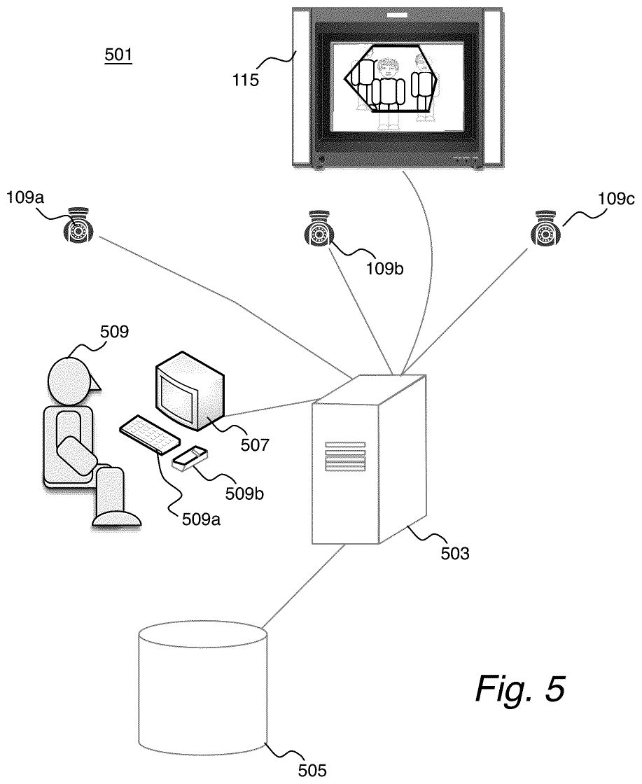

FIG. 5 is a high-level block diagram of a computer system 501 for analyzing images captured that include face capture or face tracking. An operator computer 503 is connected to the image capture devices 109a-c, the monitor 115, and a storage device 505. The operator computer 503 is further connected to an operator monitor 507 and user input devices 509a and 509b, through which an operator 509 interacts with the operator computer 503 controlling, for example, image capture and analysis programs, which may be stored in the data storage 505.

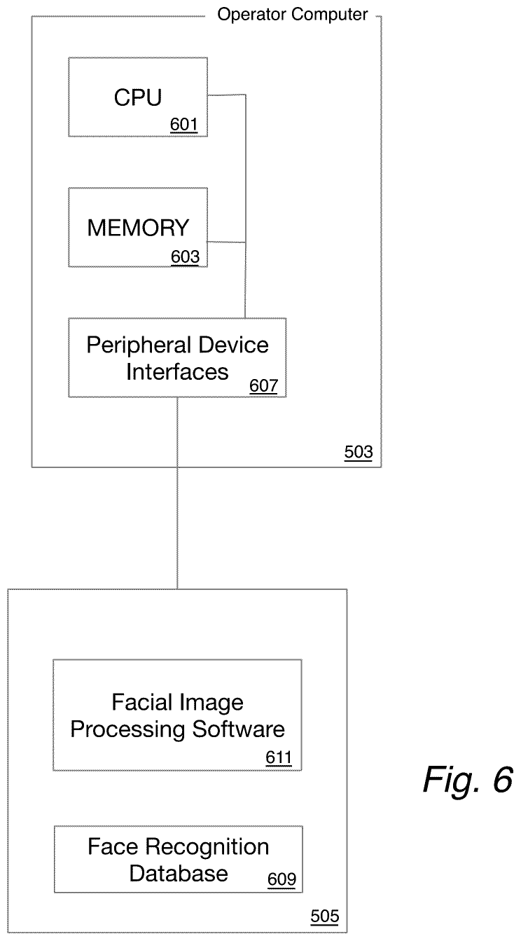

FIG. 6 is a high-level hardware architecture diagram of the operator computer 503 and the data storage 505. The operator computer 503 includes a processor 601, memory 603, and peripheral device interfaces 607. The operator computer 503 is connected to the image capture devices 109a-c, the monitor 115, the user input devices 509a and 509b, and the operator monitor 507 through the peripheral device interfaces 607.

The storage device 505 may include a face recognition database 609 for storing face recognition data, for example, to associated recognized facial data with individuals and credentials associated with particular individuals such that when an individual passes through the consent region 201, if that individual's face is recognized as being in the database and associated with a credential allowing entry, the individual is allowed passage.

The storage device 505 may further include facial image processing software 611 that is executable by the processor 601. The facial image processing software 611 may be loaded into the memory 603 for execution. The facial image processing software 611 includes instructions to direct the processor to perform the mechanisms described herein.

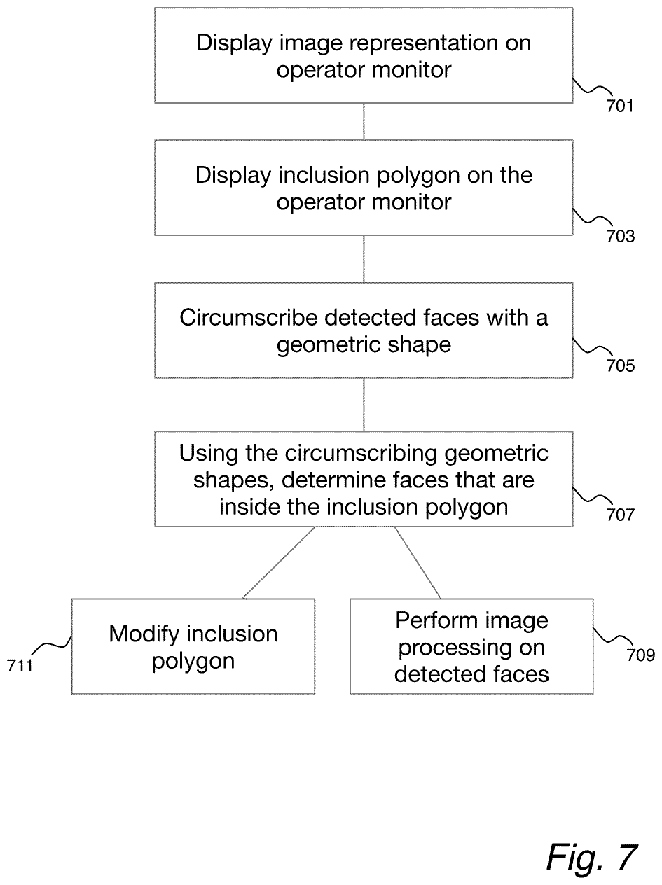

In one aspect the facial image processing software 611 provides a user interface for the operator 509 to control the facial image capturing process. The facial image processing software 611 executes according to a flow illustrated in FIG. 7. The steps illustrated in FIG. 7 are not necessarily executed in the presented order.

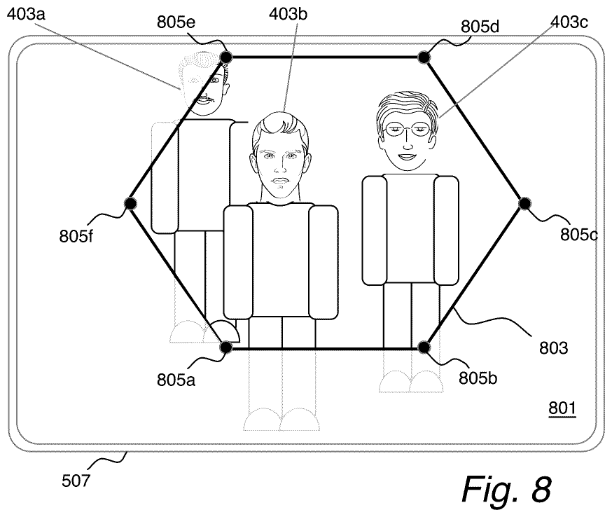

A representation of the image captured by an image capture device 109 is presented to the operator 509 on the operator's monitor 507, step 701. Such an image may be similar to the one illustrated in FIG. 8.

FIG. 8 is an illustration of a representation 801 of an image captured by an image capture device 109 and displayed to the operator 509 on the operator monitor 507.

In a step 703, an inclusion polygon 803 is superimposed on the image representation 801. The representation 801 includes the inclusion polygon 803, for example, as illustrated in FIG. 8, a hexagon. The inclusion polygon 803 is defined by vertices 805. In an embodiment, areas outside of the inclusion polygon 803 are displayed with a filter superimposed over the regions of the image representation 801 that falls outside of the inclusion polygon. Such areas are referred to herein as exclusion areas. In FIG. 8 the exclusion area is illustrated by the image being somewhat blurred with respect to the portion of the image representation 801 falling within the inclusion polygon 803. In alternative embodiments, the exclusion area may appear under a colored overlay, e.g., a blue overlay.

The representation 801 may also be displayed on the monitor 115 that displays images to the individuals passing through the environment 101. An individual can then determine whether they are being included for facial image processing when they should not be or, conversely, determine that they should step into the area included in the inclusion polygon 803 if they observe themselves to be outside of the inclusion polygon 803.

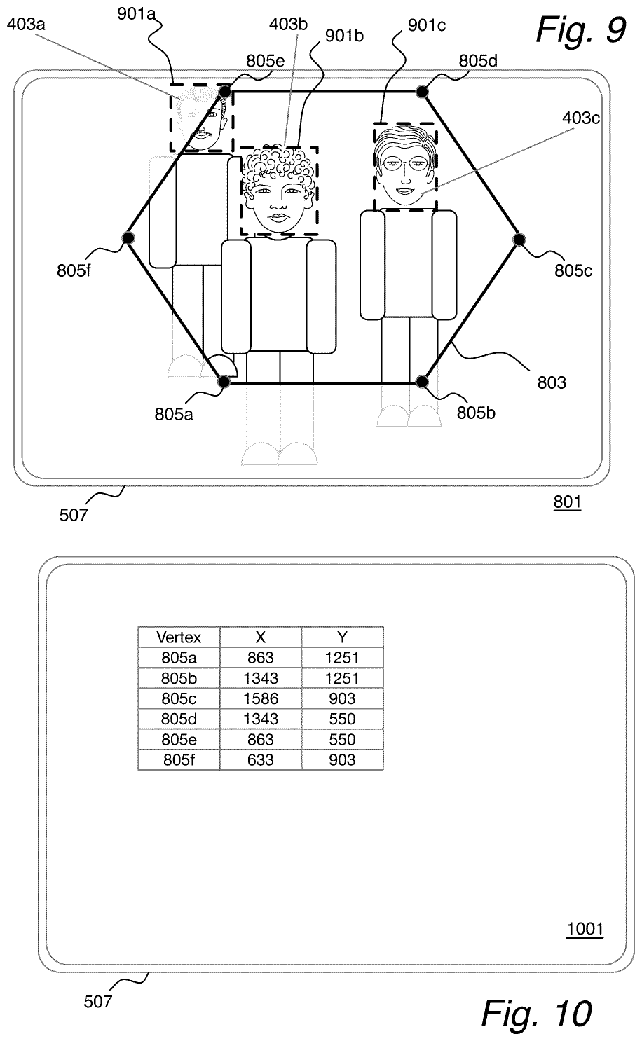

Returning to the flowchart of FIG. 7. In a step 705, detected faces are circumscribed by a surrounding geometric shape, e.g., a rectangle, as illustrated in FIG. 9. In the example, rectangles 901a-901c circumscribe the faces 403a-c of the three individuals in the scene.

In a step 707, an algorithm is applied using the circumscribing geometric shapes to determine whether a face is to be consider within the bounds of the inclusion polygon 803. In an embodiment, a face is considered to be within the inclusion polygon 803 if a minimum number of vertices of the face-circumscribing geometric shape fall inside the inclusion polygon:

Number_of_vertices_insideᵢ—number of vertices of a face-circumscribing geometric shape i that fall inside the inclusion polygon

Min_number_of_vertices—minimum number of vertices of a face-circumscribing geometric shape that must fall inside the inclusion polygon for considering the face to be in the inclusion polygon

Then,

For each face-circumscribing geometric shape i, faceᵢ is in the inclusion polygon if Number_of_vertices_insideᵢ≥Min_number_of_vertices

The minimum number of vertices of the face-circumscribing geometric shape for the face to considered to be within the inclusion polygon may be set as a parameter. In the present example, let's consider the Min_number_of_vertices value to be four, i.e., all four corners of the circumscribing rectangle must be within the inclusion polygon. In that case, both rectangle 901b and 901c are considered to be within the inclusion polygon, whereas the rectangle 901a is considered to not be within the inclusion polygon.

In a further step 709, the digital images of faces corresponding to circumscribing rectangles that are considered to be within the inclusion polygon and those digital images are further processed by the facial image processing software to determine, for example, whether the detected face corresponds to an entry in the database 609 and, thus, determining whether a person identified by such facial image processing software is to be provided entry. Accordingly, in the example of FIG. 9, the facial digital images 403b and 403c are subjected to facial image processing whereas the facial digital image 403a is excluded from facial image processing.

In a further step 711, which may be conducted prior to the image processing step 709, the operator may modify the inclusion polygon by changing the locations of the vertices 805 that define the inclusion polygon. FIG. 10 illustrates a user interface screen 1001 listing the vertex locations of the vertices of the inclusion polygon of FIGS. 8 and 9.

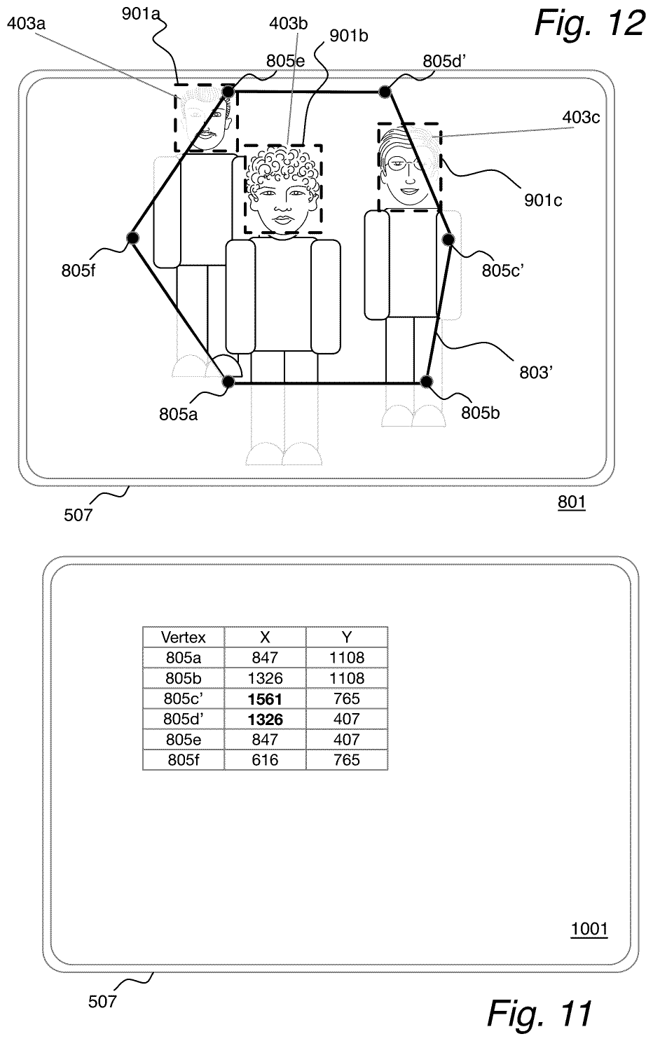

In FIG. 11, the operator has modified the coordinates for vertices 809c and 809d, designated as 809c′ and 809d′, respectively. The modified inclusion polygon 803′ is illustrated in FIG. 12. As can be seen there, the circumscribing geometric shape 901c now falls outside of the modified polygon 803′. Accordingly, the corresponding facial image 403c is not subjected to image processing.

In an embodiment, the operator 509 simply enters new coordinates for vertices 805 that they want to modify the location for. In an alternative embodiment, the modification of vertex location is performed by a drag-and-drop operation wherein the operator 509 selects a vertex to move and drags it to a new location.

In an embodiment, initial vertex locations may be established from image processing of an image from environment 101, for example, through visual clues found in the environment 101.

Consider again the example of FIG. 9. In it, the circumscribing geometric shapes 901b and 901c are within the inclusion polygon 803. There are multiple ways in which such a situation can be handled. As noted above, in some deployments, it is desirable to process only one individual 403 at a time. In such a deployment, the operator may be called upon to modify the shape of the inclusion polygon 803. Conversely, in other deployments, all individuals 403 that are deemed within the inclusion polygon 803 are processed by the image processing software, i.e., in the example of FIG. 9, in such a deployment, the face images of both individual 403b and individual 403c are subject to furter image processing.

In another scenario, where multiple individuals are within the inclusion polygon 803, that maybe indicative that individuals in the out lane 119 are inadvertently included in the inclusion polygon 803. If the operator detects such a situation, the operator may modify the shape of the inclusion polygon 803.

While the above examples describe the inclusion polygon 803 as being a hexagon, that is merely for illustrative purposes. Other shapes such as triangles, trapezoids, pentagons, or even polygons having more that six vertices may be used for the shape of the inclusion polygon. The operator user interface may provide for adding additional vertices or to remove vertices from an inclusion polygon.

Similarly, while the face-circumscribing geometric shapes are described and illustrated as being rectangles, any circumscribing geometric shape may be used. If the geometric shape is not defined by vertices, e.g., ovals, the inclusion/exclusion criteria may be based on how much of the area of the face-circumscribing geometric shape falls inside the inclusion polygon, e.g., if more than 50% falls inside the inclusion polygon.

In alternative embodiments, multiple image acquisition devices 109a-c are employed to ensure that facial images for as many as possible, if not all, individuals passing through the consent region 201 in installations where a single camera cannot cover the entire consent region 201. The above-described technique of using an inclusion polygon 803 is used with images acquired from each such image device 109a-c to ensure that facial images of individuals passing through the consent region are presented for further processing while avoiding image processing of faces from individuals who avoided the consent region 201.

From the foregoing it will be apparent that an efficient and secure mechanism for ensuring that facial images from individuals who opt in to having their facial images used by an image processing system are forwarded to the image processing system while avoiding forwarding images for individuals who opt out is provided based on whether an individual places themself within a consent region where images are captured by at least one image capture device.

Although specific aspects of the disclosure have been described and illustrated, the disclosure is not to be limited to the specific forms or arrangements of parts so described and illustrated. The disclosure is limited only by the claims.

We Claim:

1. A method for filtering subjects subject to facial image processing in a face-tracking environment, the method comprising:
capturing at least one image using an image capture device;
defining an inclusion polygon having at least three vertices such that at least one angle formed at least one of said vertices is not a right angle;
identifying a plurality of faces in said at least one image;
defining a geometric shape around each said identified plurality of faces, respectively;
excluding from further processing any of said identified faces with a defined geometric shape that falls outside the inclusion polygon or that intersects with the polygon and that fails an inclusion criteria based on an inside portion of the defined geometric shape that falls inside the polygon and an outside portion that falls outside the inclusion polygon;
including for further processing any of said identified faces with a defined geometric shape that falls entirely inside the inclusion polygon or that intersects the inclusion polygon and that passes the inclusion criteria; and
performing said further processing on said identified faces to thereby determine an identification-linked property linked to such identified faces.

2. The method of claim 1, wherein said further processing includes biometric analysis of the identified faces, and the method further comprising:
linking the identification-linked property to face-recognition biometrics for a plurality of individuals.

3. The method of claim 1, wherein said inclusion polygon is defined in a user interface by specifying vertex coordinates in captured images.

4. The method of claim 1, wherein said inclusion polygon is defined in a user interface by selecting vertices and dragging selected vertices to desired locations.

5. The method of claim 1, wherein said inclusion polygon is defined by identifying features in an image and setting the vertices defining the inclusion polygon based on said identified features.

6. The method of claim 1, wherein the inclusion polygon is selected from the set including triangles, non-rectangular quadrilaterals, pentagons, and hexagons.

7. The method of claim 1, wherein the defined geometric shapes around each said identified plurality of faces are face polygons and the inclusion criteria with respect to each said face polygon is that at least n vertices of said face polygon falls on or within the inclusion polygon, wherein n is a user-defined parameter.

8. The method of claim 1, wherein the defined geometric shapes around each said identified plurality of faces are face polygons and the inclusion criteria with respect to each said face polygon is that at least a defined number of corners of said face polygon falls on or within the inclusion polygon.

9. The method of claim 1, wherein the defined geometric shapes around each said identified plurality of faces are face polygons having a plurality of vertices and the inclusion criteria with respect to each said face polygon is that at least a defined number of said vertices of the face polygon falls on or within the inclusion polygon.

10. The method of claim 7, wherein the face polygon is a rectangle.

11. The method of claim 1, wherein the identification-linked property identifies individuals as having right to admission selected from the set including having a boarding pass to a flight or other mode of transportation, being the bearer of a passport, having right to building access.

12. A computer system for delimiting subjects from consideration in biometric matching using face-tracking technology, comprising:
a processor;
at least one image capture device;
a memory for:
storing a database linking an identification property to face-recognition biometrics; and
a computer program executable by the processor to perform a method comprising the steps of:
capturing at least one image using an image capture device;
defining an inclusion polygon having at least three vertices such that at least one angle formed at least one of said vertices is not a right angle;
identifying a plurality of faces in said at least one image;
defining a geometric shape around each said identified plurality of faces, respectively;
excluding from further processing any of said identified faces with a defined geometric shape that falls outside the inclusion polygon or that intersects with the polygon and that fails an inclusion criteria based on an inside portion of the defined geometric shape that falls inside the polygon and an outside portion that falls outside the inclusion polygon;
including for further processing any of said identified faces with a defined geometric shape that falls entirely inside the inclusion polygon or that intersects the inclusion polygon and that passes the inclusion criteria; and
performing said further processing on said identified faces to thereby determine an identification-linked property linked to such identified faces.
